(19) United States
(12) Patent Application Publication
(10) Pub. No.: US 2017/0106573 A1
(43) Pub. Date: Apr. 20, 2017

(54) INSERT MOLDING PROCESS

(71) Applicant: Nishikawa Rubber Co., Ltd., Hiroshima (JP)

(72) Inventors: Toshimichi Kawaguchi, Hiroshima (JP); Toru Abo, Hiroshima (JP)

(21) Appl. No.: 15/286,174

(22) Filed: Oct. 5, 2016

(30) Foreign Application Priority Data
Oct. 20, 2015 (JP) 2015-206197

(51) Int. Cl. B29C 45/14; B29C 45/26

(52) U.S. Cl. CPC B29C 45/14065; B29C 45/2606; B29C 2045/14114; B29K 2021/00

(57) ABSTRACT

A recess is formed on a mold for injection molding a molded product body, and communicates with a cavity of the mold. A part is bonded to the recess with an adhesive. In this state, a molten molding material is injected into the cavity to provide a molded product body, and the part and the molded product body are welded together by heat of the molten molding material. After the separation of the molded product body and the part from the mold, the adhesive is stripped from the part.

### CROSS-REFERENCE TO RELATED APPLICATION

This application claims priority to and the benefit of Japanese Patent Application No. 2015-206197, filed on Oct. 20, 2015, the contents of which as are incorporated by reference herein in their entirety.

### BACKGROUND

Related Field

The present disclosure relates to an insert molding process to provide a molded product including a molded product body and a part provided for the body.

Description of Related Art

Examples of molded products each including a molded product body and a part provided for the body include a weatherstrip for a vehicle door. A weatherstrip for a frameless door has both end portions extending along a belt line and corresponding to molded portions made by molding. A region of each molded portion over which a door glass slides tends to be damaged by the sliding, and is therefore provided with a sliding member.

For example, Japanese Patent No. 5169687 shows that a sliding tape is bonded to a region of a weatherstrip over which a door glass slides. Japanese Patent No. 5169687 further describes an insert molding process in which the cavity of a mold to which a sliding tape is fitted is filled with EPDM to provide a weatherstrip connected to the sliding tape.

Japanese Unexamined Patent Publication No. H07-112420 shows that an extrusion-molded portion of a vehicle glass run is vulcanized, and a glass sliding member including a layered film bonded thereto is welded, with a pressure roller, to the extrusion-molded portion which has just been vulcanized and in which residual heat remains. Japanese Unexamined Patent Publication No. H07-112420 further shows that a lip portion of a molded portion of the glass run has a shallow recess, and while residual heat remains in the lip portion, the glass sliding member is bonded to the recess by pressure to allow the glass sliding member to be flush with a surface of the lip portion.

For example, a heat seal is used to bond a part such as a sliding tape to a molded product body such as a weatherstrip. However, such a heat seal causes air to enter between the molded product body and the part. Thus, a gap tends to be partially formed therebetween. It is difficult to insert a heating and pressing unit into a portion of a glass run having a complex structure such as an inner portion thereof. This makes it difficult to heat-seal the part. An increase in the thickness of the part makes it more difficult to transfer heat to the interface between the molded product body and the part, resulting in greater difficulty of the heat seal itself.

Examples of known insert molding processes include an insert molding process in which a molded product body is formed with a part fitted to a mold as described above. However, it is generally difficult to temporarily fix the part to the mold such that the part stays on the mold. In particular, a film-like (or sheet-like) part is difficult to temporarily fix. In addition, the fluid pressure of a molding material charged into the cavity of a mold and other factors easily deform the film-like part.

### BRIEF SUMMARY

To address these problems, the present disclosure provides a molded product body by temporarily fixing an insert part to a mold with ease and reliability.

According to the present disclosure, a part is bonded to a mold with an adhesive to solve the problems.

Specifically, an insert molding process according to an aspect of the present disclosure is a process for provide a molded product including a molded product body and a separately shaped part provided for the molded product body. The process includes: forming a recess on a mold for injection molding the molded product body, the recess communicating with a cavity of the mold; bonding the part to the recess of the mold with an adhesive; injecting a molten molding material into the cavity with the part bonded to the recess to provide the molded product body, and welding the part and the molded product body together by heat of the molten molding material; and after separating the molded product body and the part from the mold, stripping the adhesive from the part.

According to the insert molding process, the part bonded to the mold with the adhesive allows the part to be temporarily fixed to the mold with ease and reliability. The molten molding material comes into contact with the part, and the heat of the molding material causes the contact surface of the part to melt. As a result, the part and the molded product body are welded together. This allows the part to be firmly fixed to the molded product body without any gap.

Thus, the adhesive on the recess of the mold substantially prevents the part and the adhesive from being stripped from the mold due to the fluid pressure of the molding material. In addition, the mold recess having a depth matching the thickness of the adhesive applied to the part allows a surface of the part to be flush with a surface of the molded product body.

In one embodiment, the molded product body may be made of a resin material, and the part may be made of a different resin material from that of the molded product body.

In one embodiment, the part may be coated with the adhesive, and may be bonded to the recess of the mold with the adhesive. Thus, the adhesive may be applied to the part outside the mold. This helps improve workability as compared with the application of the adhesive to the mold.

In one embodiment, the recess of the mold may have a depth matching a thickness of the adhesive.

In one embodiment, the part may be a resin film.

In one embodiment, the molded product body may be an elastomer.

In one embodiment, the molded product body may be a vehicle weatherstrip made of an elastomer, and the part may be a wear-resistant film provided on a surface of the weatherstrip over which a door glass slides.

In one embodiment, the molded product body may be a vehicle glass run made of an elastomer, and the part may be a wear-resistant film provided on a surface of the glass run over which a door glass slides.

### BRIEF DESCRIPTION OF THE FIGURES

FIG. 1 is a perspective view, partially in cross section, illustrating a molded product according to an embodiment of the present disclosure.

FIG. 2 is a perspective view, partially in cross section, illustrating a part coated with an adhesive.

FIG. 3 is a cross-sectional view illustrating a state in which a part coated with an adhesive is bonded to a recess of a mold.

FIG. 4 is a perspective view, partially in cross section, illustrating a state in which an adhesive is stripped from a molded product that has been separated from a mold.

FIG. 5 is a perspective view illustrating a portion of a weatherstrip according to a first example.

FIG. 6 is a cross-sectional view of a mold used to mold the weatherstrip.

FIG. 7 is a cross-sectional view illustrating a state in which a wear-resistant film coated with an adhesive is bonded to a portion of a mold.

FIG. 8 is a cross-sectional view of a molded product separated from a mold and including an adhesive.

FIG. 9 is a cross-sectional view illustrating a state in which an adhesive is being stripped from a molded product.

FIG. 10 is a perspective view illustrating a portion of a glass run according to a second example.

FIG. 11 is a cross-sectional view illustrating a state in which the glass run is attached to a vehicle body.

FIG. 12 is a cross-sectional view of a mold used to mold the glass run.

### DETAILED DESCRIPTION OF VARIOUS EMBODIMENTS

Embodiments of the present disclosure will now be described with reference to the drawings. The following preferred embodiments are merely illustrative ones in nature, and are not intended to limit the scope, applications, and use of the invention.

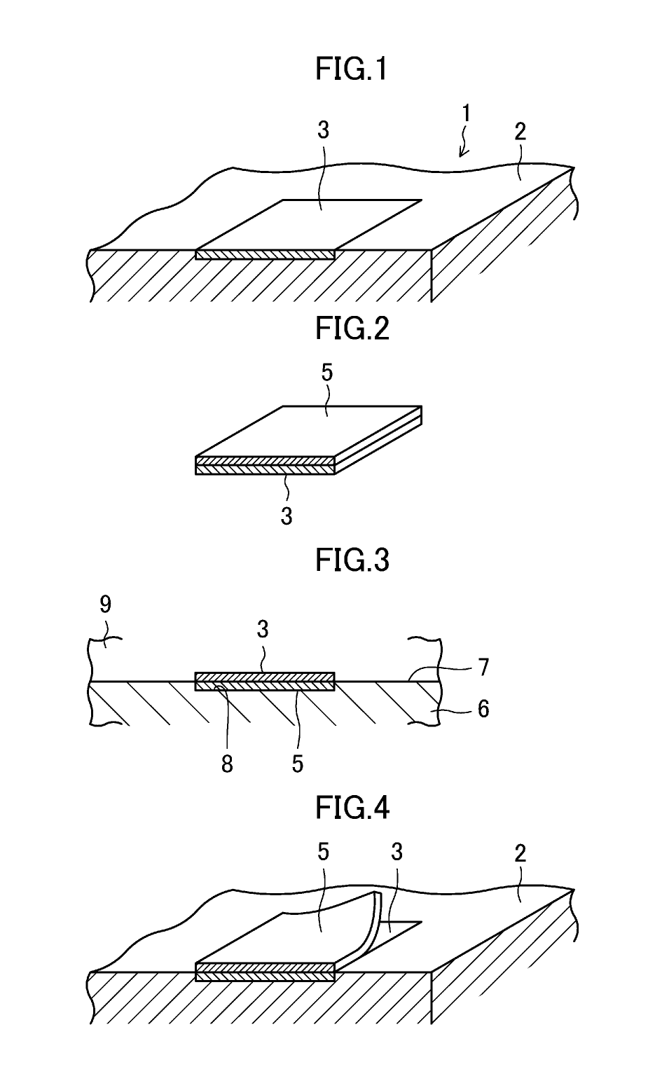

The molded product 1 shown in FIG. 1 includes a molded product body 2, and a part 3 provided for the molded product body 2. The molded product body 2 according to this embodiment is formed of an injection-molded resin material. The part 3 according to this embodiment is made of a resin film. The molded product body 2 and the part 3 are welded together. The part 3 has a surface flush with a surface of the molded product body 2.

To make a resinous molded product 1, one surface of the part 3 is coated with an adhesive 5 as illustrated in FIG. 2. As illustrated in FIG. 3, a recess 8 to which the part 3 is to be bonded is formed on a predetermined portion of a molding surface 7 of a mold 6 for injection molding the molded product body 2. This recess 8 communicates with a cavity 9 of the mold 6. The recess 8 is designed to have a depth matching the thickness of the adhesive 5 applied to the part 3.

Then, the part 3 is bonded to the recess 8 of the molding surface 7 of the mold 6 with the adhesive 5. This allows the part 3 to be temporarily fixed to the mold 6. In this state, a molten resin material is injected into the cavity 9 of the mold 6 to provide the molded product body 2 (injection molding). At this time, the surface of the part 3 melts due to the heat of the molten resin material. As a result, the molded product body 2 and the part 3 are welded together, thereby preventing a gap from being formed between the molded product body 2 and the part 3. Furthermore, the adhesive 5 fitted into the recess 8 of the mold 6 substantially prevents the part 3 and the adhesive 5 from being stripped from the mold 6 or deforming due to the fluid pressure of the resin material during injection molding.

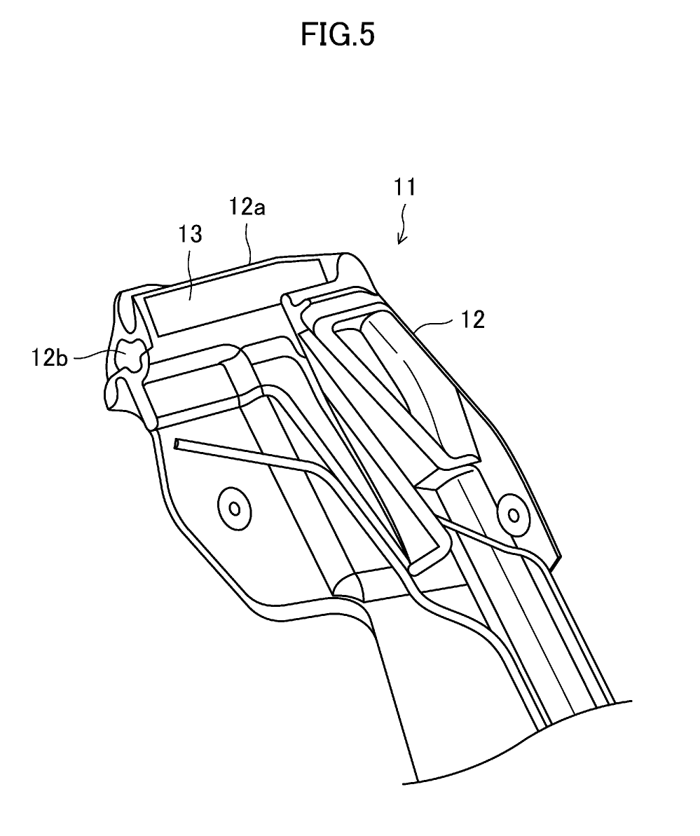

After the molded product body 2 and the part 3 are separated from the mold 6, the adhesive 5 is stripped from the part 3 as illustrated in FIG. 4. Thus, the molded product 1 is obtained. Since the recess 8 of the mold 6 has a depth matching the thickness of the adhesive 5 applied to the part 3, the surface of the part 3 is flush with the surface of the molded product body 2.

Examples of the adhesive 5 that may be suitably used include a single component, moisture-curable elastic adhesive. It takes time for this type of elastic adhesive to be reactively cured. Thus, when the molded product body 2 and the part 3 are separated from the mold 6, the elastic adhesive may be easily stripped from the mold 6, and also after the molded product body 2 and the part 3 are separated from the mold 6, the elastic adhesive may be easily stripped from the part 3.

### First Example (Application of the Disclosure to Weatherstrip)

FIG. 5 illustrates a weatherstrip 11 provided on a corner portion of the upper edge of the periphery of a door panel, i.e., a molded product, for a hardtop vehicle. The weatherstrip 11 comes into contact with the periphery of a door opening of a vehicle body to seal the cabin. This weatherstrip 11 includes a weatherstrip body 12 made of an olefinic thermoplastic elastomer (TPO), and a resinous wear-resistant film 13 provided for the weatherstrip body 12. The weatherstrip body 12 corresponds to a molded product body, and the wear-resistant film 13 corresponds to a part. The wear-resistant film 13 is provided on a lip portion 12a of an upper end portion of the weatherstrip body 12 over which a door glass slides with the raising and lowering of the door glass.

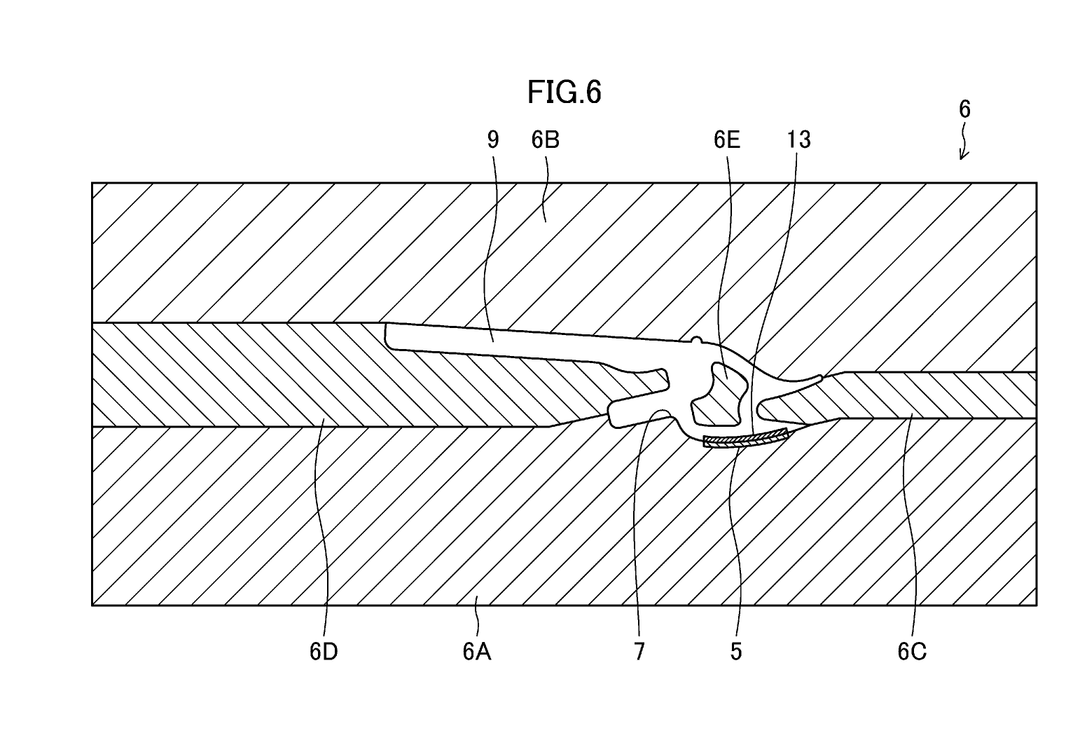

FIG. 6 illustrates a mold 6 used to make the weatherstrip 11. The mold 6 according to this example includes a first mold portion 6A used to shape a surface of the weatherstrip body 12 inside the vehicle, a second mold portion 6B used to shape a surface of the weatherstrip body 12 outside the vehicle, a third mold portion 6C used to shape an upper surface of the weatherstrip body 12, a fourth mold portion 6D used to shape a lower surface of the weatherstrip body 12, and a core 6E used to shape a hollow portion 12b of the weatherstrip body 12. These mold portions 6A-6D and the core 6E define a cavity 9 for molding the weatherstrip body 12.

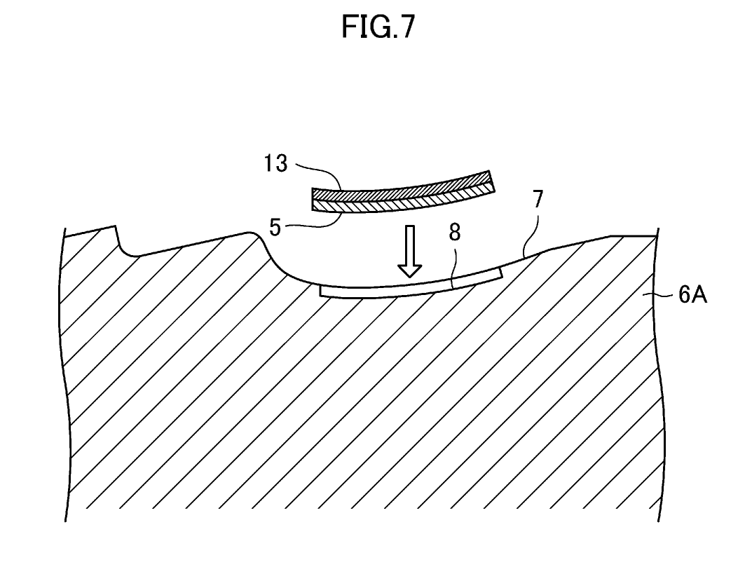

As illustrated in FIG. 7, a molding surface 7 of the first mold portion 6A has a recess 8 to which the wear-resistant film 13 is to be bonded with an adhesive 5. This recess 8 has a depth matching the thickness of the adhesive 5 applied to the wear-resistant film 13.

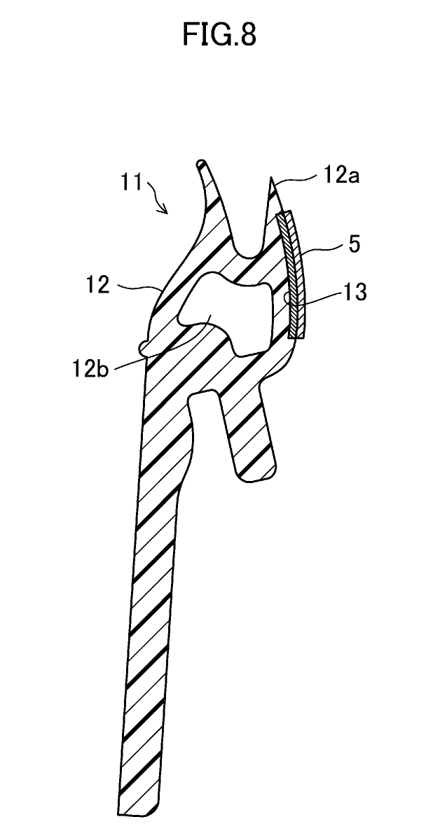

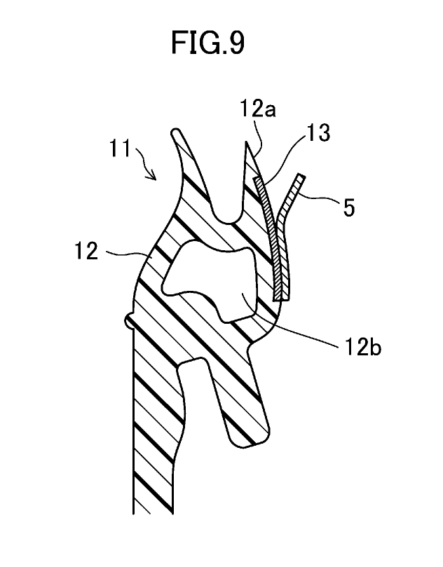

To make the weatherstrip 11, the wear-resistant film 13 having one surface coated with the adhesive 5 is bonded to the recess 8 of the first mold portion 6A with the adhesive 5 as illustrated in FIG. 7. Then, a combination of the mold portions 6A-6D and the core 6E defines the cavity 9 as illustrated in FIG. 6. A molten resin material injected into the cavity 9 forms the weatherstrip body 12 (injection molding). As illustrated in FIG. 8, the adhesive 5 sticks to the wear-resistant film 13 of the weatherstrip 11 that has been separated from the mold 6. Thus, as illustrated in FIG. 9, the adhesive 5 is stripped from the wear-resistant film 13 to obtain the weatherstrip 11 shown in FIG. 5.

Just like the molded product 1, the adhesive 5 fitted into the recess 8 of the mold 6 substantially prevents the wear-resistant film 13 and the adhesive 5 from being separated from the mold 6 or deforming due to the fluid pressure of the resin material during injection molding. The surface of the wear-resistant film 13 melts by the heat of the molten resin material. As a result, the weatherstrip body 12 and the wear-resistant film 13 are welded together, thereby preventing a gap from being formed therebetween. Since the recess 8 of the mold 6 has a depth matching the thickness of the adhesive 5 applied to the wear-resistant film 13, the surface of the weatherstrip body 12 of the weatherstrip 11 is flush with the surface of the wear-resistant film 13 when the weatherstrip body 12 is separated from the mold 6 and the adhesive 5 is then stripped from the wear-resistant film 13. This substantially prevents the wear-resistant film 13 from being stripped from the weatherstrip body 12 even if the door glass comes into contact with the wear-resistant film 13. As a result, the wear-resistant film 13 reliably functions to protect the weatherstrip 11 from the door glass.

### Second Example (Application of the Disclosure to Glass Run)

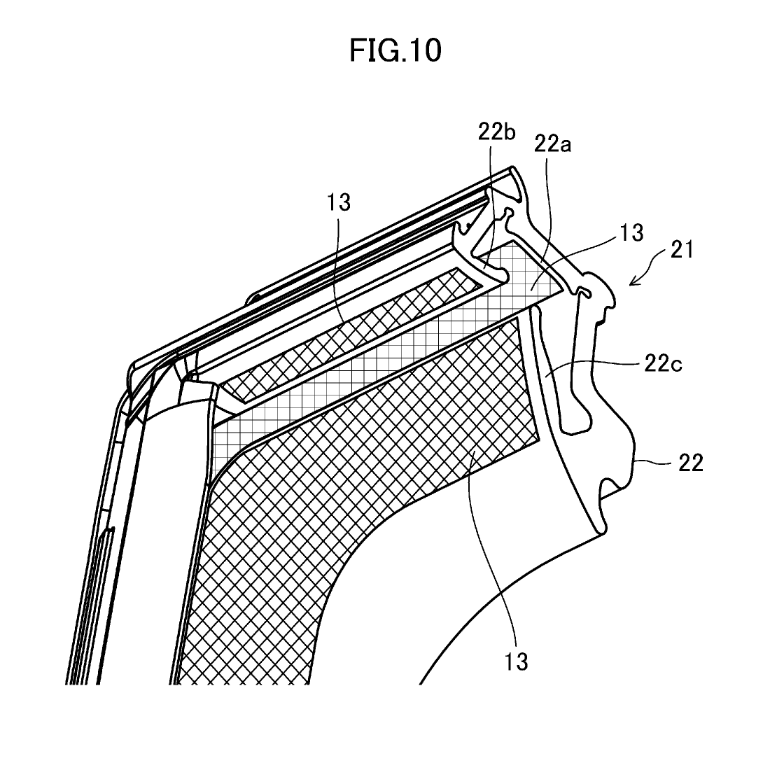

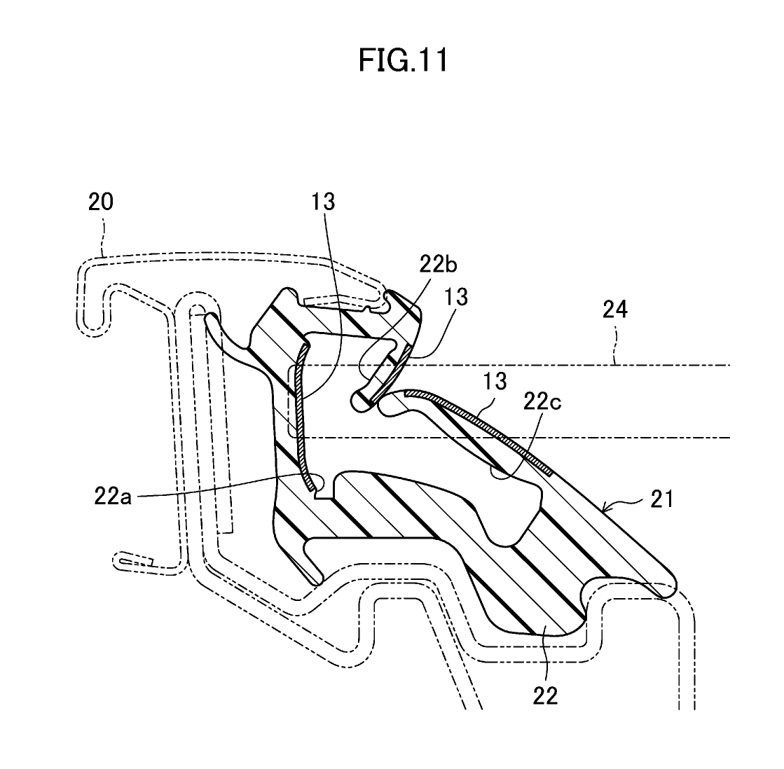

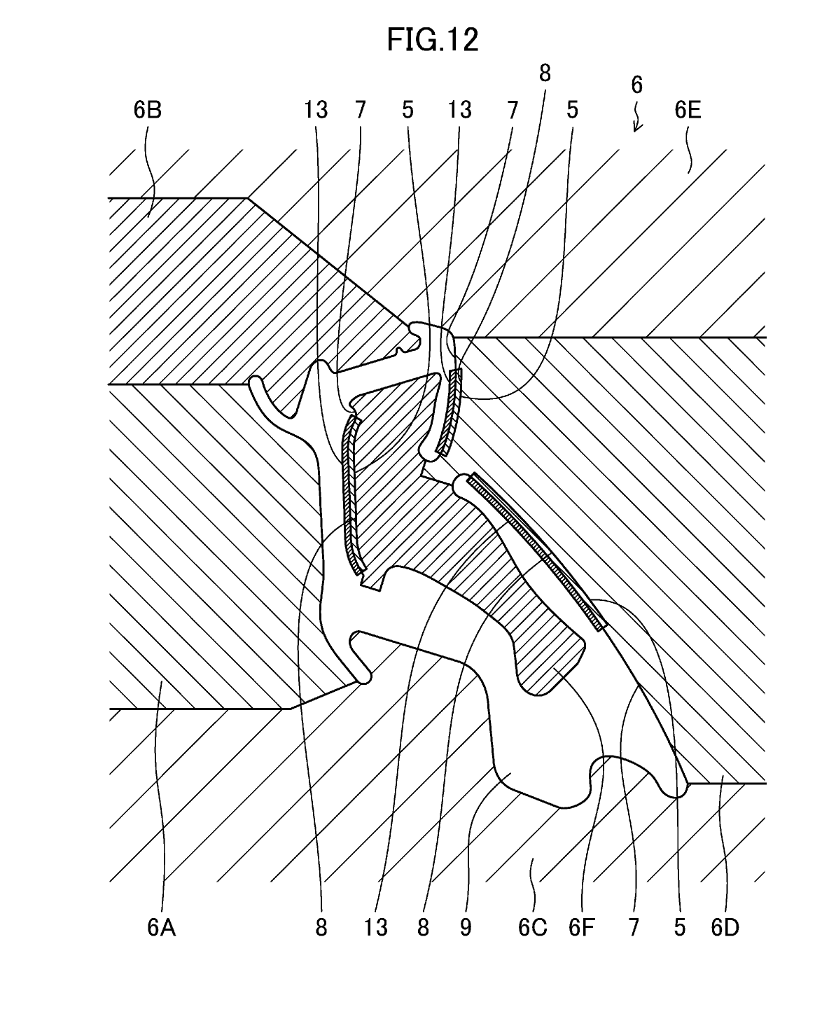

FIGS. 10 and 11 illustrate a glass run 21 provided on a corner of a door sash 20 of a vehicle. This glass run 21 corresponds to a molded product, and includes a glass run body 22 made of TPO, and resinous wear-resistant films 13 provided on the glass run body 22. The glass run body 22 corresponds to a molded product body, and the wear-resistant films 13 each correspond to a part. The glass run body 22 is injection-molded so as to be connected to a separately extrusion-molded glass run (not shown). The wear-resistant films 13 are each arranged on one of a bottom 22a and lips 22b, 22c of the glass run body 22 over which the door glass 24 slides with the raising and lowering of the door glass 24.

FIG. 12 illustrates a mold 6 used to make the glass run 21. The mold 6 according to this example includes a first mold portion 6A used to shape a back surface of the glass run body 22, second and third mold portions 6B and 6C used to shape both side surfaces of the glass run body 22, a fourth mold portion 6D used to shape a front surface of the glass run body 22 including the lips 22b, 22c, a fifth mold portion 6E used to shape a corner portion of the glass run body 22 defined by one of the side surfaces and the front surface thereof, and a core 6F. These mold portions 6A-6E and the core 6F define a cavity 9 for molding the glass run body 22.

The core 6F used to shape the inner side surface of the glass run body 22 and the fourth mold portion 6D used to shape the front surface of the glass run body 22 including the lips 22b, 22c each have one or more molding surfaces 7 each having a recess 8 to which an associated one of the wear-resistant films 13 is to be bonded with an adhesive 5. The recess 8 has a depth matching the thickness of the adhesive 5 applied to the associated wear-resistant film 13.

To make the glass run 21, each of the wear-resistant films 13 having one surface coated with the adhesive 5 is bonded to the recess 8 on an associated one of the molding surfaces 7 with the adhesive 5. Then, a combination of the mold portions 6A-6E and the core 6F defines the cavity 9 as illustrated in FIG. 12. A molten resin material injected into the cavity 9 forms the glass run body 22 (injection molding). The adhesive 5 sticks to the wear-resistant films 13 of the glass run 21 separated from the mold 6. Thus, the adhesive 5 is stripped from the wear-resistant films 13 to obtain the glass run 21 shown in FIG. 10.

Just like the molded product 1, the adhesive 5 fitted into the recesses 8 of the mold 6 substantially prevents the wear-resistant films 13 and the adhesive 5 from being separated from the mold 6 or deforming due to the fluid pressure of the resin material during injection molding. The surfaces of the wear-resistant films 13 melt by the heat of the molten resin material. As a result, the glass run body 22 and the wear-resistant films 13 are welded together, thereby preventing a gap from being formed therebetween. Since the recesses 8 of the mold 6 each have a depth matching the thickness of the adhesive 5 applied to the associated wear-resistant film 13, the surface of the glass run body 22 of the glass run 21 is flush with the surfaces of the wear-resistant films 13 when the glass run body 22 is separated from the mold 6 and the adhesive 5 is then stripped from the wear-resistant film 13. This substantially prevents the wear-resistant films 13 from being stripped from the glass run body 22 even if the door glass 24 comes into contact with the wear-resistant films 13. As a result, the wear-resistant films 13 reliably function to protect the glass run 21 from the door glass 24.

### Others

The foregoing examples of application are obtained by applying the present disclosure to vehicle parts. However, the present disclosure may naturally be applied not only to vehicle parts, but also to general resinous molded products. The present disclosure may be applied to any resinous molded product body irrespective of which of a rubber-like elastic material and a hard body that does not substantially have rubber-like elasticity is used as the resinous molded product body.

In the first and second examples, TPO was used as a material of the molded product. However, another elastomer, such as EPDM, may be used without any problem.

The parts may also be made of any other resin material, such as polyethylene or polyamide, instead of polypropylene.

What is claimed is:

1. An insert molding process for providing a molded product including a molded product body and a separately shaped part provided for the molded product body, the process comprising the steps of:
forming a recess on a mold for injection molding the product body, the recess communicating with a cavity of the mold;
bonding the part to the recess of the mold with an adhesive;
injecting a molten molding material into the cavity with the part bonded to the recess to provide the molded product body, and welding the part and the molded product body together by heat of the molten molding material; and
after separating the product body and the part from the mold, stripping the adhesive from the part.

2. The insert molding process of claim 1, wherein:
the product body is made of a resin material, and
the part is made of a different resin material from that of the molded product body.

3. The insert molding process of claim 1, wherein the part is coated with the adhesive and is bonded to the recess of the mold with the adhesive.

4. The insert molding process of claim 2, wherein the part is coated with the adhesive and is bonded to the recess of the mold with the adhesive.

5. The insert molding process of claim 1, wherein the recess of the mold has a depth matching a thickness of the adhesive.

6. The insert molding process of claim 2, wherein the recess of the mold has a depth matching a thickness of the adhesive.

7. The insert molding process of claim 3, wherein the recess of the mold has a depth matching a thickness of the adhesive.

8. The insert molding process of claim 4, wherein the recess of the mold has a depth matching a thickness of the adhesive.

9. The insert molding process of claim 1, wherein the part is a resin film.

10. The insert molding process of claim 1, wherein the molded product body is an elastomer.

11. The insert molding process of claim 1, wherein:
the molded product body is a vehicle weatherstrip made of an elastomer, and
the part is a wear-resistant film provided on a surface of the weatherstrip over which a door glass slides.

12. The insert molding process of claim 1, wherein:
the molded product body is a vehicle glass run made of an elastomer, and
the part is a wear-resistant film provided on a surface of the glass run over which a door glass slides.
